(19) United States
(12) Patent Application Publication
(10) Pub. No.: US 2011/0040410 A1
(43) Pub. Date: Feb. 17, 2011

(54) APPARATUS AND METHOD CONTROLLING LEGGED MOBILE ROBOT

(75) Inventors: Joo Hyung KIM, Seongnam-si (KR); Kyung Shik Roh, Seongnam-si (KR); Woong Kwon, Seongnam-si (KR); Jeong Heon Han, Seoul (KR); Jae Ho Park, Suwon-si (KR); Ho Seong Kwak, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/853,879

(22) Filed: Aug. 10, 2010

(30) Foreign Application Priority Data
Aug. 14, 2009 (KR) 10-2009-74986

(51) Int. Cl. B25J 9/00

(52) U.S. Cl. 700/260; 901/1

(57) ABSTRACT

Disclosed is an apparatus and method adjusting motion of each joint of a robot to compensate for friction force of each joint such that the sole of the foot of the robot clings to the ground. The motion of each joint is adjusted as if gravity acts on each joint of the robot in a direction opposite to gravity and the robot is held in an erect state. Therefore, the robot can stand while keeping its balance without falling.

### CROSS-REFERENCE TO RELATED APPLICATIONS

This application claims the benefit of Korean Patent Application No. 2009-0074986, filed on Aug. 14, 2009 in the Korean Intellectual Property Office, the disclosure of which is incorporated herein by reference.

### BACKGROUND

1. Field

Example embodiments relate to an apparatus and method controlling a legged mobile robot, which may balance the legged mobile robot to prevent falling.

2. Description of the Related Art

Recently, research into a robot which walks erect has been actively conducted.

If there is an inclined surface, such as stairs or a rough plane, or an obstacle when a robot walks, a legged robot has greater mobility than a wheeled robot. In particular, since the legged robot may lose its balance and fall, stability is taken into consideration when the walking pattern of the robot is set.

In order to guarantee the dynamic stability of a legged robot, research into generation of a walking pattern in consideration of a Zero Moment Point (ZMP) has been suggested.

The ZMP refers to a point where the sum of all moments due to force generated in the sole of the foot becomes 0. That is, the ZMP is a point where the level of reaction between the foot and the ground becomes 0 on a surface in which the foot of the robot and the ground are in contact with each other. If the ZMP is within a support surface in which the sole of the foot and the ground are in contact with each other, the robot may walk without falling.

If the motion pattern of the legged robot is generated such that the ZMP is always within the contact surface between the sole of the foot and the ground at every moment when the robot moves, the robot is stably held.

In recent methods for balancing a legged robot, a strategy for joint motion is established such that the ZMP is positioned within the support surface, thereby achieving optimization to satisfy restricted conditional expressions.

Such methods may fall in local minima or cause a computation time to be increased in achieving optimization. In addition, there is a need for a control strategy for balancing the robot according to the model of the robot. Since such a strategy is changed according to a robot system to be controlled, it is difficult to establish the strategy using a general method.

### SUMMARY

The foregoing and/or other aspects are achieved by providing a legged mobile robot that can efficiently balance itself to prevent falling by compensating for friction force of each joint of a robot, changing a gravity direction of each joint of the robot to a direction opposite to gravity, and controlling the motion of the robot, and a method controlling the same.

Additional aspects, features, and/or advantages of embodiments will be set forth in part in the description which follows and, in part, will be apparent from the description, or may be learned by practice of the disclosure.

The foregoing and/or other aspects are achieved by providing an apparatus controlling a legged mobile robot, the apparatus including: a joint unit to drive an actuator mounted in a robot joint; and a control unit to move the joint unit to compensate for friction force of the robot joint to cancel the mechanical friction force of the robot joint, and to move the joint unit in a direction opposite to gravity so that the joint unit moves as though gravity is moving in the opposite direction.

The control unit may include a friction force compensation unit to compensate for the friction force of the robot joint, an anti-gravity compensation unit to compensate for the anti-gravity of the robot joint, and a joint control unit to control motion of the robot joint.

The friction force compensation unit may compensate for the friction force of the robot joint through feedforward control.

The friction force compensation unit may compensate for the friction force of the robot joint and the robot joint moves as if the friction force is not generated.

The friction force compensation unit may receive a goal joint angular velocity which is a control input, estimate the friction force of the robot joint based on the received joint angular velocity, generate a compensation signal corresponding to the friction force to compensate for the estimated friction force, and provide the generated compensation signal to the joint unit.

The anti-gravity compensation unit may compensate for the anti-gravity of the robot joint through feedforward control.

The anti-gravity control unit may receive a goal joint angle which is a control input, estimate the anti-gravity of the robot joint based on the received joint angle, generate a compensation signal corresponding to the anti-gravity to compensate for the estimated anti-gravity, and provide the generated compensation signal to the joint unit.

The joint control unit may control the motion of the robot joint through feedback control.

The foregoing and/or other aspects are achieved by providing an apparatus controlling a legged mobile robot, the apparatus including: a joint unit to drive an actuator mounted in a robot joint; and a control unit to perform at least one of an operation to move the joint unit to compensate for friction force of the robot joint to cancel the mechanical friction force of the robot joint, and an operation to move the joint unit in a direction opposite to gravity so that the joint unit moves as though gravity is moving in the opposite direction.

The control unit may include a friction force compensation unit to compensate for the friction force of the robot joint through feedforward control and an anti-gravity compensation unit to compensate for the movement of the robot joint in the opposite direction to gravity of the robot joint through the feedforward control.

The friction force compensation unit may model the friction force of the robot joint using a goal joint angular velocity which is a control input, generate a compensation signal corresponding to the modeled friction force, and provide the compensation signal to the joint unit, and the anti-gravity compensation unit may model the movement of the robot joint in the opposite direction to gravity of the robot joint using a goal joint angle which is a control input, generate a compensation signal corresponding to the modeled movement of the robot joint in the opposite direction to gravity, and provide the compensation signal to the joint unit.

The foregoing and/or other aspects are achieved by providing a method of controlling a legged mobile robot, the method including: moving a joint unit to compensate for friction force of the robot joint to cancel the mechanical friction force of a robot joint; and moving the joint unit in a direction opposite to gravity so that the joint unit moves as though gravity is moving in the opposite direction, while compensating for the friction force of the robot joint.

The method may further include receiving a goal joint angular velocity which is a control input; estimating the friction force of the robot joint based on the received joint angular velocity; generating a compensation signal corresponding to the friction force to compensate for the estimated friction force; and moving the robot joint according to the generated compensation signal.

The method may further include receiving a goal joint angle which is a control input; estimating the movement of the robot joint in the opposite direction to gravity of the robot joint based on the received joint angle; generating a compensation signal corresponding to the movement of the robot joint in the opposite direction to gravity to compensate for the estimated movement of the robot joint in the opposite direction to gravity; and moving the robot joint according to the generated compensation signal.

The friction force of each joint of the robot is modeled and is compensated for through feedforward control to control the motion of the robot joint and the robot joint moves as if the friction force is not generated. In addition, the movement of the robot joint in the opposite direction to gravity acting on the robot is modeled and is compensated for through feedforward control to control the motion of the robot and the robot joint moves as if gravity were acting in reverse. Therefore, even when external force is applied, the robot can be efficiently held in a balanced state without falling.

In addition, although the dynamic equation of a whole robot system is not known, the robot can stand while keeping its balance if the friction force and gravity models of the robot joint are known. In addition, since the present method is different from the existing methods of balancing a robot by achieving optimization, the problems of the existing methods, such as the establishment of control strategies for balancing the robot according to robot models, do not occur.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a view showing the appearance of a legged mobile robot according to example embodiments;

FIG. 2 is a view showing the structure of the main joints of the legged mobile robot shown in FIG. 1;

FIG. 3 is a control block diagram showing an apparatus for controlling a legged mobile robot according to example embodiments;

FIG. 4 is a view illustrating a detailed control method of a control unit shown in FIG. 3;

FIGS. 5A to 5C are views illustrating correlation between friction force acting on a robot joint and the position of a Zero Moment Point (ZMP);

FIG. 6A is a view illustrating gravity acting on the legged mobile robot in a gravity direction according to example embodiments;

FIG. 6B is a view illustrating (N−1) times of gravity acting on the legged mobile robot in an anti-gravity direction according to example embodiments; and

FIG. 7 is a flowchart illustrating a method of controlling a legged mobile robot according to example embodiments.

### DETAILED DESCRIPTION

Reference will now be made in detail to embodiments, examples of which are illustrated in the accompanying drawings, wherein like reference numerals refer to like elements throughout.

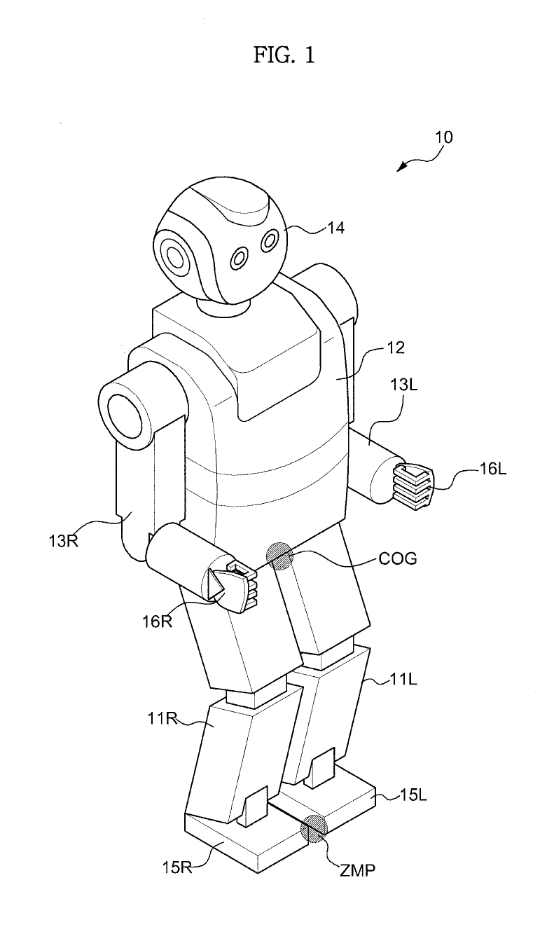

FIG. 1 is a view showing the appearance of a legged mobile robot according to example embodiments.

As shown in FIG. 1, the robot 10 is a bipedal robot which walks erect using two legs 11R and 11L similar to a human, and includes a trunk 12, two arms 13R and 13L and a head 14 mounted on an upper side of the trunk 12. The robot 10 further may include feet 15R and 15L and hands 16R and 16L respectively mounted on the front ends of the two legs 11R and 11L and the arms 13R and 13L. Regarding the reference numerals, R and L respectively denote right and left, COG denotes the center of gravity of the robot 10, ZMP denotes a point where moments of a roll axis direction (x-axis direction which is the traveling direction of the robot) and a pitch axis direction (y-axis direction which is the left and right pace direction of the robot) become 0 on a contact surface between the robot 10 and the ground.

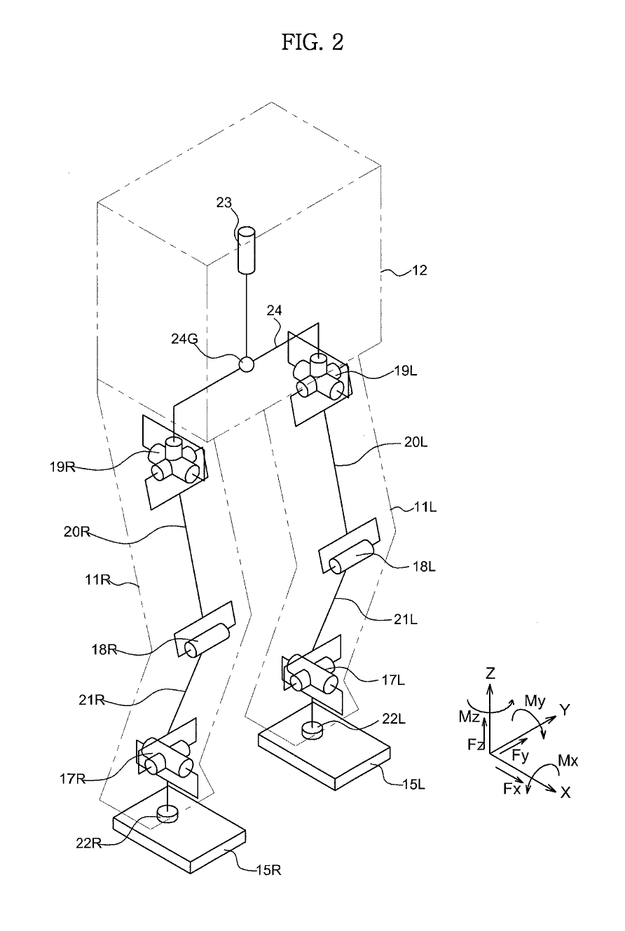

FIG. 2 is a view showing the structure of the main joints of the legged mobile robot shown in FIG. 1.

As shown in FIG. 2, the two legs 11R and 11L respectively include ankle joints 17R and 17L, knee joints 18R and 18L and hip joints 19R and 19L so as to rotate the ankles, the knees and the hips of the robot 10. The hip joints 19R and 19L are located on both ends of the lower side of the trunk 12, which are connected to the two legs 11R and 11L.

The ankle joints 17R and 17L of the legs 11R and 11L may move in the x-axis direction (roll axis direction which is the traveling direction of the robot) the y-axis direction (pitch axis direction which is the left and right pace direction of the robot), the knee joints 18R and 18L may move in the y-axis direction (pitch axis direction), and the hip joints 19R and 19L may move in the x-axis direction (roll axis direction), the y-axis direction (pitch axis direction) and a z-axis direction (yaw axis direction).

The two legs 11R and 11L respectively include upper links 20R and 20L to connect the hip joints 19R and 19L and the knee joints 18R and 18L and lower links 21R and 21L to connect the knee joints 18R and 18L and the ankle joints 17R and 17L such that the robot may walk with a predetermined degree of freedom according to the motion of the joints 17R and 17L, 18R and 18L, 19R and 19L, and 22R and 22L. Force and Torque (F/T) sensors 22R and 22L are mounted on the ankles of the legs 11R and 11L such that three-directional components Fx, Fy and Fz of force received from the feet 15R and 15L and three-directional components Mx, My and Mz of moment are measured and ZMP information is provided.

The trunk 12 connected to the two legs 11R and 11L includes a waist joint 23 so as to rotate the waist of the robot 10, and the waist joint 23 is located on the same axis line as a central position 24G of a hip link 24 to connect the hip joints 19R and 19L located on both ends of the lower side of the trunk 12. Although not shown, each of all the joints 17R and 17L, 18R and 18L, 19R and 19L, and 22R and 22L of the robot 10 includes an actuator (e.g., a motor).

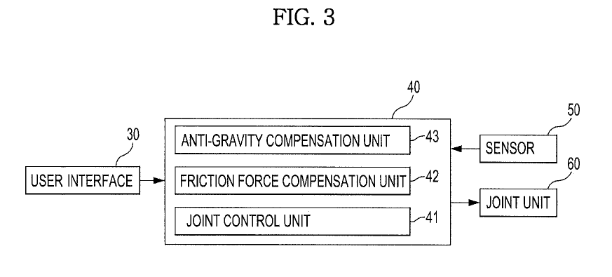

FIG. 3 is a control block diagram showing an apparatus controlling a legged mobile robot according to example embodiments.

As shown in FIG. 3, the apparatus controlling the legged mobile robot according to example embodiments includes a control unit 40, a user interface 30 to allow a user to input a user command to control the robot, a joint unit 60 to drive an actuator, such as a motor, which is mounted in each of the joints of the robot, and a sensor 50 mounted in the robot to measure force applied to each of the joints or attitude information of the robot.

The control unit 40 controls the motion of the robot based on the user command input through the user interface 30 and the information provided by the sensor 50.

The control unit 40 includes a joint control unit 41, a friction force compensation unit 42, and an anti-gravity compensation unit 43. The joint control unit 41 generates a joint signal to control the motion of the joint unit 60 using a goal joint angle of a robot joint, which is a control input, and a current joint angle input through the sensor 50, and outputs the joint signal to the joint unit 60, thereby controlling the motion of the joint unit 60.

The friction force compensation unit 42 receives a goal joint angular velocity of the robot joint, which is a control input, models the friction force of each of the joints, and generates a compensation signal corresponding to the friction force of each of the joints. The compensation signal is added to the joint signal output to the joint unit 60 by the joint control unit 41 to adjust the motion of each of the joints such that the friction force of each of the joints is compensated for to cancel the mechanical friction force of each of the joints. The friction force compensation unit 42 enables each of the joints of the robot to act as if mechanical friction force is not generated. Accordingly, a positional variation in ZMP is minimized such that the sole of the foot of the robot clings to the ground. At this time, the friction force of the robot joint may be detected using a friction force estimator or a separate acceleration sensor. In these methods, the friction force may be estimated by acquiring an accurate parameter of the robot joint and estimating or measuring a variation in acceleration due to friction force.

The anti-gravity compensation unit 43 receives a goal joint angle of a robot joint, which is a control input, models the anti-gravity of each of the joints, and generates a compensation signal corresponding to the anti-gravity of each of the joints. The compensation signal is added to the joint signal output to the joint unit 60 by the joint control unit 41 so as to adjust the motion of each of the joints such that the gravity acts on each of the joints of the robot in an anti-gravity direction opposite to a gravity direction, thereby compensating for the anti-gravity of each of the joints. That is, the anti-gravity compensation unit 43 adjusts the motion of each of the joints as if gravity reversely acts on each of the joints of the robot, and the robot is held in an erect state.

By the friction force compensation and anti-gravity compensation, the robot may be held in an erect state and balanced without falling even when external force is applied to the robot.

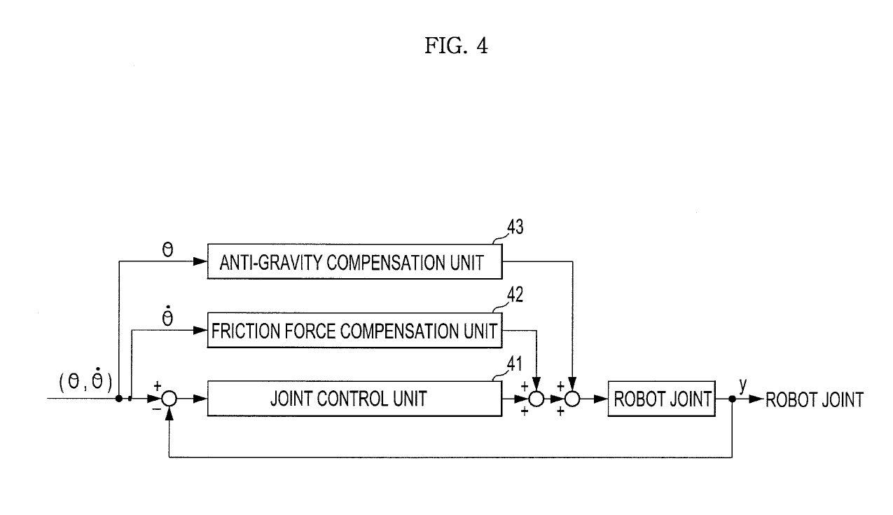

FIG. 4 is a view illustrating a detailed control method of the control unit shown in FIG. 3.

As shown in FIG. 4, the apparatus controlling the legged mobile robot according to example embodiments includes a control loop using sensor feedback performed by the joint control unit 41 using a general method of controlling the robot joint. The apparatus further includes two feedforward control loops. The two feedforward control loops include a feedforward control loop for friction force compensation performed by the friction force compensation unit 42 and a feedforward control loop for anti-gravity compensation performed by the anti-gravity compensation unit 43. At this time, the anti-gravity compensation may be performed even when a feedback control loop is used instead of the feedforward control loop for anti-gravity compensation.

The friction force of the robot joint used in the feedforward control loop for friction force compensation is a function expressed by the angular velocity of the robot joint, and the gravity acting on the joint, which is used in the feedforward control loop for anti-gravity compensation, is a function expressed by the angle of the robot joint. These functions may be obtained based on a physical model given when the robot is designed and may be verified by experimentation or simulation.

The joint control unit 41 used in the control loop using sensor feedback may be any one of a Proportional controller (P controller), a Proportional Integral controller (PI controller), a Proportional Differential controller (PD controller), and a Proportional Integral Differential controller (PID controller).

The feedforward control loop for friction force compensation receives the goal joint angular velocity of the robot joint, which is the control input, models the friction force of the robot joint, generates the compensation signal corresponding to the friction force of the robot joint, and provides the compensation signal to the robot joint, thereby compensating for the friction force of the robot joint. Accordingly, the mechanical friction force of the robot joint is cancelled such that the robot joint acts as if mechanical friction force is not generated.

The feedforward control loop for anti-gravity compensation receives the goal joint angle of the robot joint, which is the control input, models the anti-gravity of the robot joint, generates the compensation signal corresponding to the anti-gravity of the robot joint, and provides the compensation signal to the robot joint, thereby compensating for the anti-gravity of the robot joint. Accordingly, the robot joint moves as if gravity reversely acts on the robot joint and the robot is held in an erect state.

Hereinafter, in order to describe the operation of the example embodiments, influence of the friction force of each of the joints on the ZMP in the legged mobile robot will be described.

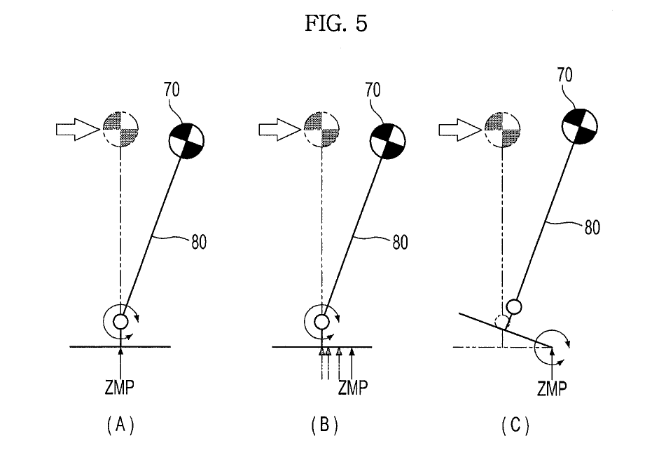

FIGS. 5A-5C show the motion of a legged mobile robot having one joint, which falls free when external force denoted by an arrow is applied to the robot held in an erect state. At this time, reference numeral 70 denotes a pendulum when the motion of the robot joint is pendulum motion and reference numeral 80 denotes a pendulum axis.

FIG. 5A shows where friction force is not generated, FIG. 5B shows where friction force is generated, and FIG. 5C shows where friction force is strongly generated.

If it is assumed that gravity acts on an ideal mechanism without friction force, the mechanism naturally freefalls along a locus satisfying a mechanical constraint. However, the mechanical friction force acts on the joint such that the mechanism moves at a velocity lower than a free-fall velocity or stops.

If the friction force is not generated as shown in FIG. 5A, the ZMP (an arrow directed from the bottom to the sole of the foot) is always positioned under the joint.

However, if the friction force is weak, as shown in FIG. 5B, the ZMP is moved, but is not deviated from the sole of the foot, which is a support surface.

Meanwhile, if the friction force is strong as shown in FIG. 5C, since the robot joint is not moved by large friction force, the sole of the foot is moved using an edge of the sole of the foot as an axis due to influence of external force. At this time, the ZMP is positioned on the edge which becomes the axis.

As can be seen from FIGS. 5A-5C, when the robot freefalls, a positional variation in ZMP is decreased as friction force is decreased. If the ZMP is positioned within the support surface and the positional variation is small, the robot may balance itself. Therefore, if the friction force is compensated for, the robot may balance itself.

Even when the friction force of the robot joint is compensated for, the robot may not stand while keeping its balance. In order to balance the robot, the robot needs to be held in an erect state. In the example embodiments, a method of controlling the motion of the robot joint to reverse the gravity direction of the robot is suggested as a control method for holding the robot in the erect state.

Hereinafter, gravity acting reversely on a robot joint will be described.

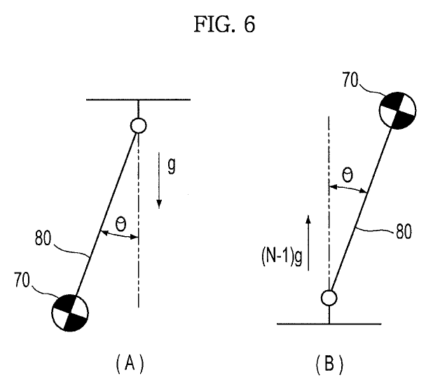

FIG. 6A is a view illustrating gravity acting on the robot joint in a gravity direction according to example embodiments, and FIG. 6B is a view illustrating (N−1) times of gravity acts on the robot in an anti-gravity direction according to example embodiments.

As shown in FIG. 6, a pendulum 70 is suspended in a gravity direction.

When input torque for control or force is not externally applied, the motion of the pendulum 70 may be expressed by the following equation.

M(θ)\ddot{θ}+C(θ,\dot{θ}) \dot{θ}+g(θ)=0 Equation 1

where, θ denotes an n×1 positional vector of the joint, M(θ) denotes an n×n inertia matrix, C(θ, \dot{θ}) denotes an n×1 vector indicating Coriolis force and centripetal force, and g(θ) denotes an n×1 gravity vector.

The pendulum 70 shown in FIG. 6A continuously performs pendulum motion downward due to gravity.

As shown in FIG. 6B, if it is assumed that the gravity direction is an upward direction by reversing this model, a model which continuously performs pendulum motion upward is obtained. If the gravity direction is reversed and input torque Ng(θ) which is N times a gravity vector g(θ) is applied, the dynamic equation of the robot joint may be expressed by Equation 2.

M(θ)\ddot{θ}+C(θ, \dot{θ}) \dot{θ}+g(θ)=Ng(θ) Equation 2
Equation 2 may be rearranged to Equation 3.

M(θ)\ddot{θ}+C(θ,\dot{θ}) \dot{θ}(1−N)g(θ)=0 Equation 3
where, N denotes a constant.

As shown in FIG. 6B, the motion of the robot joint is controlled such that the robot joint acts as if (N−1) times gravity acts on the robot joint upward. At this time, as N is increased, the robot joint rapidly reaches a goal value and thus the shake width of the robot joint is decreased.

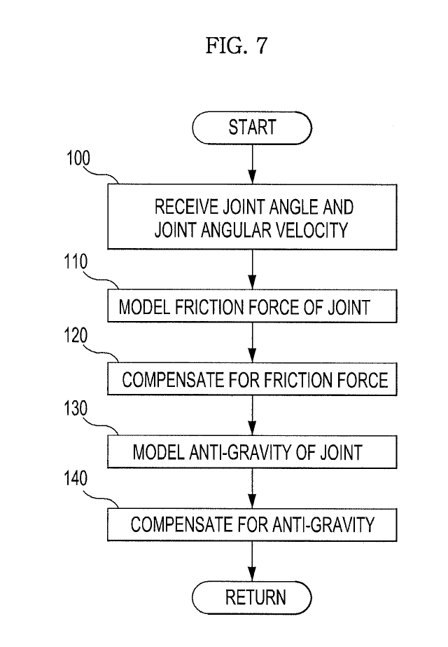

FIG. 7 is a flowchart illustrating a method for compensating for friction force and anti-gravity of a robot joint in an apparatus controlling a legged mobile robot according to example embodiments.

Referring to FIG. 7, the control unit 40 receives a joint angle and a joint angular velocity of the robot joint, which are control inputs, in order to move the robot joint (100).

The control unit 40 models the friction force of the robot joint based on the joint angular velocity of the robot joint (110). At this time, the friction force is estimated based on the joint angular velocity of the robot joint and the compensation signal corresponding to the friction force is generated to compensate for the friction force.

After modeling the friction force of the robot joint, the control unit 40 provides the compensation signal corresponding to the friction force of the robot joint to the joint unit 60 through feedforward control to control the motion of the robot joint to compensate for the friction force of the robot joint (120). Thus, the mechanical friction force of the robot joint is cancelled and the robot joint acts as if the mechanical friction force is not generated. Since the robot joint acts as if the mechanical friction force is not generated, a positional variation in ZMP is minimized and the sole of the foot of the robot clings to the ground.

After compensating for the friction force of the robot joint, the control unit 40 models the anti-gravity of the robot joint based on the joint angle of the robot joint (130). At this time, the anti-gravity of the robot is estimated based on the joint angle of the robot joint and the compensation signal corresponding to the anti-gravity is generated such that the anti-gravity is compensated for.

After modeling the anti-gravity of the robot joint, the control unit 40 provides the compensation signal corresponding to the anti-gravity of the robot joint to the joint unit 60 through feedforward control to control the motion of the robot joint such that the anti-gravity of the robot joint is compensated for (140). Therefore, the robot joint moves as if gravity acts in reverse on the robot joint and the robot is held in an erect state.

As described above, the friction force is compensated for through feedforward control and the robot joint moves as if gravity acts in reverse such that a positional variation in ZMP is decreased and the robot is held in an erect state. In other words, the robot balances itself without falling.

The example embodiments provide a method of enabling a legged mobile robot to stand while keeping its balance and holding the robot in an erect state. According to the example embodiments, the robot can stand while keeping its balance if the friction force and gravity models of the robot joint are known although the dynamic equation of a whole robot system is not known. In addition, since the present method is different from the existing methods for balancing a robot by achieving optimization, the problems of the exiting methods do not occur.

The method according to the above-described example embodiments may also be implemented through computer readable code/instructions stored in/on a medium, e.g., a computer readable medium, to control at least one processing element to implement any above described embodiment. The medium can correspond to a non-transitory medium/media permitting the storing or transmission of the computer readable code. The computer readable medium may also be embodied in at least one application specific integrated circuit (ASIC) or Field Programmable Gate Array (FPGA).

The computer readable code can be recorded or transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media. The media may also be a distributed network, so that the computer readable code is stored or transferred and executed in a distributed fashion. Still further, as only an example, the processing element could include at least one processor or at least one computer processor, and processing elements may be distributed or included in a single device.

In addition to the above described embodiments, example embodiments can also be implemented as hardware, e.g., at least one hardware based processing unit including at least one processor capable of implementing any above described embodiment. The described hardware devices may be configured to act as one or more software modules in order to perform the operations of the above-described exemplary embodiments, or vice-versa.

Although embodiments have been shown and described, it should be appreciated by those skilled in the art that changes may be made in these embodiments without departing from the principles and spirit of the disclosure, the scope of which is defined in the claims and their equivalents.

What is claimed is:

1. An apparatus controlling a legged mobile robot, the apparatus comprising:
a joint unit to drive an actuator mounted in a robot joint; and
a control unit to move the joint unit, to compensate for friction force of the robot joint to cancel the mechanical friction force of the robot joint, and to move the joint unit in a direction opposite to gravity so that the joint unit moves as though gravity is moving in the opposite direction.

2. The apparatus according to claim 1, wherein the control unit includes a friction force compensation unit to compensate for the friction force of the robot joint, an anti-gravity compensation unit to compensate for movement of the robot joint in the opposite direction to gravity, and a joint control unit to control motion of the robot joint.

3. The apparatus according to claim 2, wherein the friction force compensation unit compensates for the friction force of the robot joint through feedforward control.

4. The apparatus according to claim 3, wherein the friction force compensation unit compensates for the friction force of the robot joint and the robot joint moves as if the friction force is not generated.

5. The apparatus according to claim 4, wherein the friction force compensation unit receives a goal joint angular velocity which is a control input, estimates the friction force of the robot joint based on the received joint angular velocity, generates a compensation signal corresponding to the friction force to compensate for the estimated friction force, and provides the generated compensation signal to the joint unit.

6. The apparatus according to claim 2, wherein the anti-gravity compensation unit compensates for the movement of the robot joint in the opposite direction to gravity through feedforward control.

7. The apparatus according to claim 6, wherein the anti-gravity compensation unit receives a goal joint angle which is a control input, estimates the movement of the robot joint in the opposite direction to gravity based on the received joint angle, generates a compensation signal to compensate for the estimated movement of the robot joint in the opposite direction to gravity, and provides the generated compensation signal to the joint unit.

8. The apparatus according to claim 2, wherein the joint control unit controls the motion of the robot joint through feedback control.

9. An apparatus controlling a legged mobile robot, the apparatus comprising:
a joint unit to drive an actuator mounted in a robot joint; and
a control unit to perform at least one of an operation to move the joint unit to compensate for friction force of the robot joint to cancel the mechanical friction force of the robot joint, and an operation to move the joint unit in a direction opposite to gravity so that the joint unit moves as though gravity is moving in the opposite direction.

10. The apparatus according to claim 9, wherein the control unit includes a friction force compensation unit to compensate for the friction force of the robot joint through feedforward control and an anti-gravity compensation unit to compensate for the movement of the robot joint in the opposite direction to gravity through the feedforward control.

11. The apparatus according to claim 10, wherein:
the friction force compensation unit models the friction force of the robot joint using a goal joint angular velocity which is a control input, generates a compensation signal corresponding to the modeled friction force, and provides the compensation signal to the joint unit, and
the anti-gravity compensation unit models the movement of the robot joint in the opposite direction to gravity using a goal joint angle which is a control input, generates a compensation signal corresponding to the modeled movement of the robot joint in the opposite direction to gravity, and provides the compensation signal to the joint unit.

12. A method of controlling a legged mobile robot, the method comprising:
moving a joint unit to compensate for friction force of a robot joint to cancel the mechanical friction force of the robot joint; and
moving the joint unit in a direction opposite to gravity so that the joint unit moves as though gravity is moving in the opposite direction, while compensating for the friction force of the robot joint.

13. The method according to claim 12, further comprising:
receiving a goal joint angular velocity which is a control input;
estimating the friction force of the robot joint based on the received joint angular velocity;
generating a compensation signal corresponding to the friction force to compensate for the estimated friction force; and
moving the robot joint according to the generated compensation signal.

14. The method according to claim 13, further comprising:
receiving a goal joint angle which is a control input;
estimating the movement of the robot joint in the opposite direction to gravity based on the received joint angle;
generating a compensation signal to compensate for the estimated movement of the robot joint in the opposite direction to gravity; and
moving the robot joint according to the generated compensation signal.
